(19) United States
(12) Patent Application Publication
(10) Pub. No.: US 2002/0051240 A1
(43) Pub. Date: May 2, 2002

(54) Dual transmissive/reflective image scanning apparatus

(75) Inventors: Jih-Yung Lu, Taipei (TW); Jung-Ying Tu, Taipei (TW)

Correspondence Address: ARENT FOX KINTNER PLOTKIN & KAHN, 1050 CONNECTICUT AVENUE, N.W., SUITE 600, WASHINGTON, DC, 20036, US

(73) Assignee: ACER COMMUNICATIONS & MULTIMEDIA INC.

(21) Appl. No.: 09/750,353

(22) Filed: Dec. 29, 2000

(30) Foreign Application Priority Data
Jun. 9, 2000 (TW) 089111358

(51) Int. Cl. H04N 1/04

(52) U.S. Cl. 358/474

(57) ABSTRACT

The present invention provides a dual transmissive/reflective image scanning apparatus for improving the scanning quality of reflective originals. The present invention includes a slot for selectively accommodating a tray of a first type or a tray of a second type. For reflective scanning, the tray of the first type, which includes a means of transparent material such as glass, is inserted within the slot. For transmissive scanning, the tray of the second type without a means of transparent material may be selectively inserted within the slot. As scanning transparent originals, a light source from the original cover passes directly thought the transparent originals and thus it reduces obstruction that may be caused by a transparent material. Furthermore, either the tray of the first type or the tray of the second type is allowed to be withdrawn from the housing for cleaning greasy dirt or dust deposited on the glass or installing various holders for transparent originals.

### FIELD OF THE INVENTION

The present invention relates to an image scanning apparatus and more particularly to a dual transmissive/reflective image scanning apparatus.

### BACKGROUND OF THE INVENTION

Typically, there are three main categories of image scanning apparatuses including transmissive scanners for transparent originals such as slides and transparencies, reflective scanners for opaque originals such as documents and photographs, and transmissive/reflective scanners for both transparent originals and opaque originals.

A conventional transmissive/reflective scanner includes a glass platen upon which either a transparent original or an opaque original is placed. When scanning the transparent original, a light source from the original cover illuminates through not only the transparent original but also the glass platen. Usually the original cover includes another glass platen on one surface, and this glass platen is in touch with the original when scanning. However, glass may cause reflection and refraction, and loss of light is resulted as light passes through. Placing the transparent original between the aforementioned two pieces of glass may cause more loss of light. Additionally, greasy dirt and dust may easily gather on the glass platen during use. When settling down or taking back the original from the glass platen installed on the upper surface of the housing, the glass platen is particularly easily smudged. With the conventional scanner, only dirt and dust deposited on the upper surface of the glass platen is allowed to be cleaned. That deposited on the lower surface of the glass platen can not be cleaned because the glass platen is not allowed to be taken out from the housing. Moreover, with the design of two pieces of glass, the transparent original located between the two pieces of glass can not be flattened when the aforementioned two pieces of glass are not smoothly in touch with each other. Therefore the images become deformed and out of focus.

A transmissive/ reflective image scanning apparatus has been disclosed in U.S. Pat. No. 5,574,274. It provides a light source within the housing instead of within the original cover for transmissive scanning. Although some of the problems have been solved, it leads to a higher manufacturing cost due to the complication of the light traveling pathway.

In order to solve the aforementioned problems, the present invention provides a dual transmissive/reflective image scanning apparatus including two types of trays, which are used for transparent originals or opaque originals respectively. When scanning transparent originals, no glass is present on the housing so that the light source only passes through a piece of glass of the original cover. Therefore, the design of the light traveling pathway remains unchanged and a high scanning quality is achieved.

### SUMMARY OF THE INVENTION

The present invention relates to a dual transmissive/reflective image scanning apparatus. The present invention provides a tray of a first type for reflective scanning and a tray of a second type for transmissive scanning. Thus the present invention achieves a higher scanning quality than the prior art and makes it easier to clean greasy dirt and dust deposited on both upper and lower surface of the glass platen installed on the housing.

The present invention has a slot within which the tray of the first type or the tray of the second type may be selectively inserted. For reflective scanning, the tray of the first type, which includes a means of transparent material such as glass, is inserted within the slot. While on the other hand, for transmissive scanning, the tray of the second type without glass may be selectively inserted within the slot. When scanning transparent originals, a light source from the original cover passes directly through the transparent originals. Since the light passes through only one glass platen (which is set on the original cover), refraction of light is lower than the prior art. Therefore, it achieves a high scanning quality. Furthermore, either the tray of the first type or the tray of the second type is allowed to be withdrawn from the housing for cleaning greasy dirt or dust deposited on the glass or placing various holders for transparent originals.

### BRIEF DESCRIPTION OF THE DRAWING

FIG. 1 illustrates the body of the image apparatus in accordance with the present invention.

FIG. 2 illustrates the tray of the first type in accordance with the present invention.

FIG. 3 illustrates the tray of the second type in accordance with the present invention.

FIG. 4 illustrates the tray of the first type that is completely inserted within the slot.

FIG. 5 illustrates the tray of the second type that is completely inserted within the slot.

FIG. 6 illustrates a sectional view of the slot that is formed by the upper surface of the frame and the inner surface of the housing.

### DETAIL DESCRIPTION OF THE PRESENT INVENTION

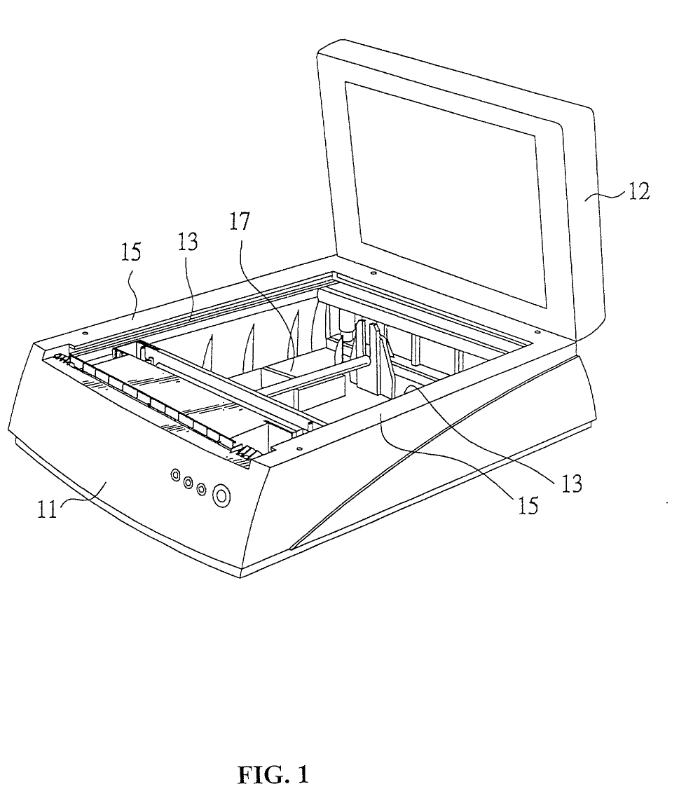

Referring to FIG. 1, the present invention includes a housing 11 and an original cover 12. The housing 11 has an upper surface 15 which provides a cavity 17 at a substantially central position. The original cover 12 is rotatably attached to the housing 11 to selectively cover or uncover the upper surface 15 of the housing 11. A light source (not shown), disposed inside the original cover 12, is provided to illuminate transparent originals. A slot 13 along the edge of the cavity 17 is formed inside the housing 11. Generally speaking, the slot 13 is formed along the left and right sides of the upper surface 15 close to the inner surface of the housing 11.

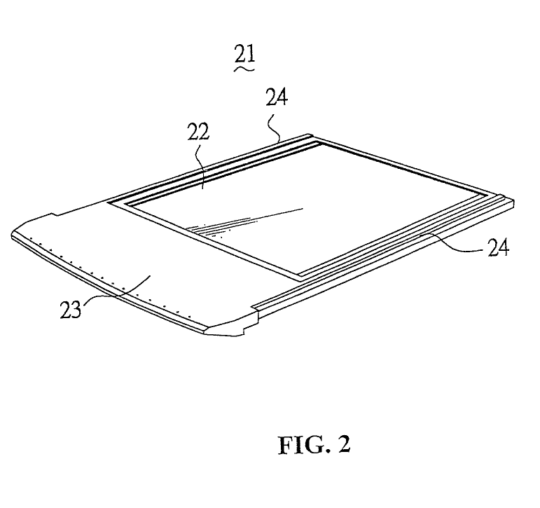

FIG. 2 illustrates the tray of the first type 21 used for reflective image scanning in accordance with the present invention. A transparent material means 22 is installed at a substantially central position of the tray of the first type 21. The preferred material for the transparent material means 22 is glass. A slide guide 24, formed at both left and right edges of the tray of the first type 21, is used to slide within the slot 13 (shown in FIG. 1). The tray of the first type 21 further includes a holding section 23.

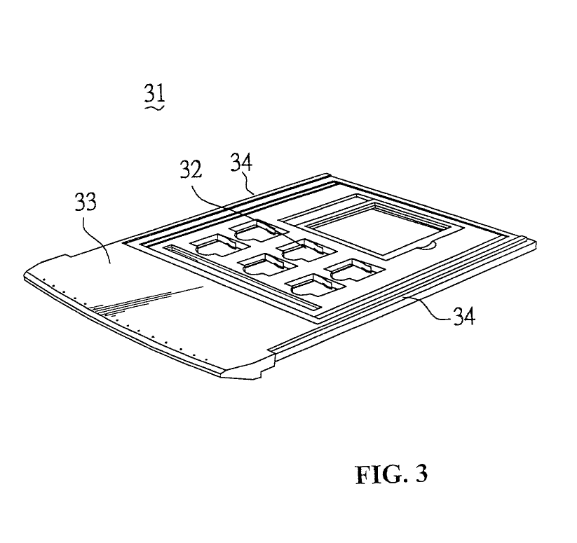

FIG. 3 illustrates the tray of the second type 31 used for transmissive image scanning in accordance with the present invention. At least one holder 32, installed at a substantially central position in the tray of the second type 21, is used to hold transparent originals thereon. The holder 32 comes in a variety of configurations, and transparent originals such as positive films can be positioned on the holder 32. A slide guide 34, formed at both left and right edges of the tray of the second type 31, is used to slide within the slot 13 (shown in FIG. 1). The tray of the second type 31 further provides a holding section 33.

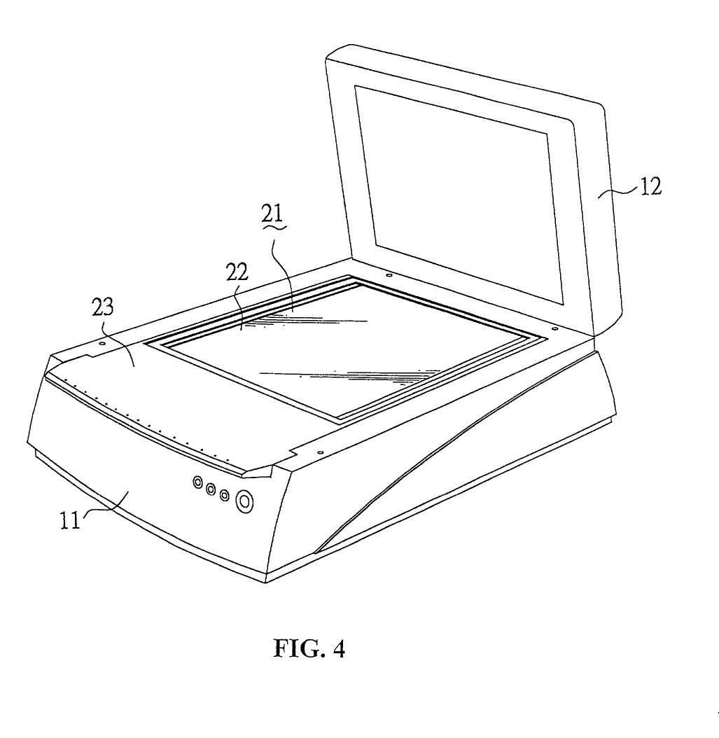

The tray of the first type 21 is allowed to be inserted within and may slide within the slot 13. FIG. 4 illustrates the status that the tray of the first type is completely inserted within the slot 13.

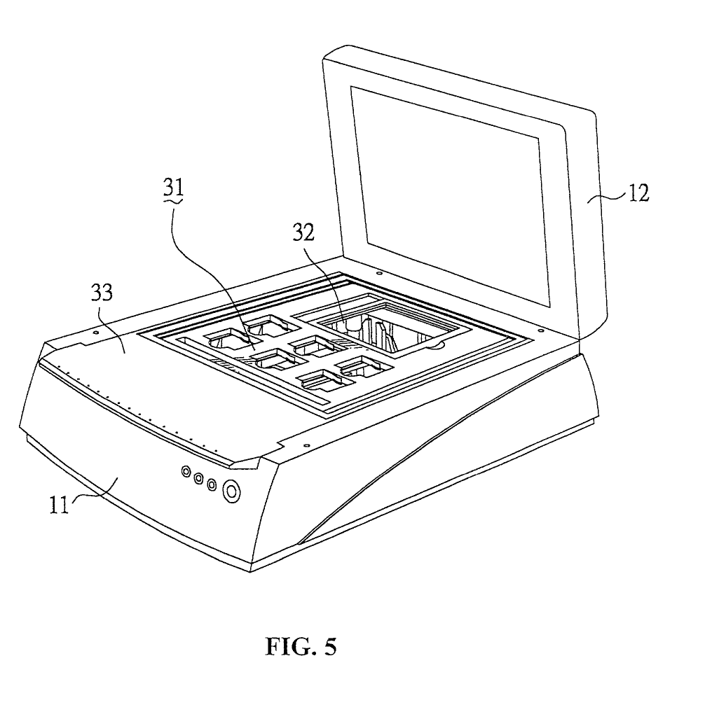

The tray of the second type 31 is allowed to be inserted within and may slide within the slot 13. FIG. 5 illustrates the status that the tray of the second type 31 is completely inserted within the slot 13.

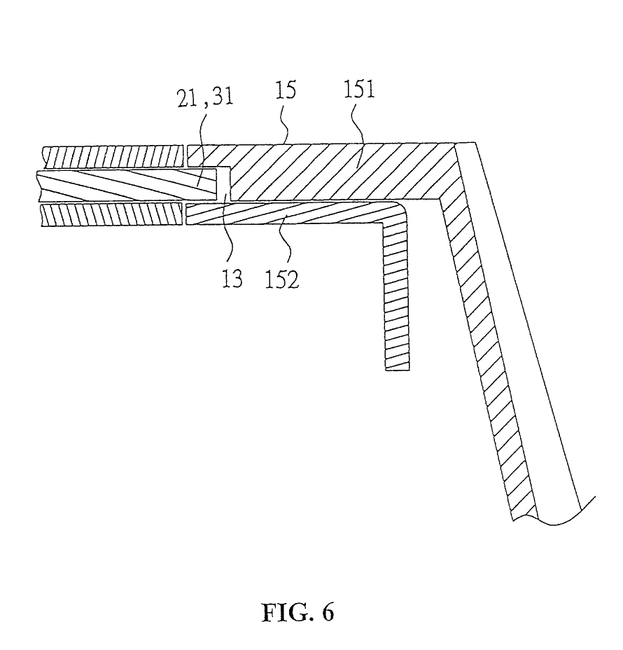

FIG. 6 illustrates a cross-section of the slot 13 of the housing 11. As mentioned above, the present invention provides a pair of slot 13 that the tray of the first type 21 or the tray of the second type 31 may slide into the housing 11. The slot 13 is formed by an upper surface of a frame 152 and an inner surface of a housing shell 151. The cross-section of the frame 152 is in substantially L-shape and the cross-section of the slot 13 is in substantially U-shape whose opening faces the tray of the first type 21 or the tray of the second type 31. The slot 13 is parallel to the longitudinal direction of the housing 11, and the U-shaped opening of the slot 13 is facing the transverse direction of the housing 11. In another embodiment, the slot 13 may also be parallel to the transverse direction of the housing 11, and therefore the U-shaped opening of the slot 13 is facing the longitudinal direction of the housing 11.

The present invention provides a dual transmissive/reflective image scanning apparatus. For reflective scanning, the tray of the first type 21 is inserted within the slot 13. Users are allowed to clean greasy dirt or dust deposited on the upper surface and the lower surface of the glass platen installed on the upper surface of the housing 11 after the tray of the first type 21 is completely withdrawn from the housing 11, in order to improve the scanning quality.

For transmissive scanning, the tray of the second type 31 may be selectively inserted within the slot 13. When scanning transparent originals, the light source from the original cover 12 passes directly through the transparent originals. Because light is not obstructed by the conventional glass platen, which may prior art be installed on the upper surface of the housing 11, it reduces refraction and reflection of light, and therefore a desirable scanning quality is achieved. Furthermore, when the tray of the first type 21 is inserted within the slot 13 and the transparent originals are placed on the means of transparent material 22, the light source from the original cover 12 may also execute the transmissive scanning.

It will be understood that certain features and sub-combinations are of utility and may be employed without reference to other features and sub-combinations as they are outlined within the claims. While the preferred embodiment and application of the invention has been described, it is apparent to those skilled in the art that the originals and features of the present invention are only limited as set forth in claims attached hereto.

What is claimed is:

1. An image scanning apparatus, comprising:
a housing, the housing having an upper surface, an inner surface and a slot means, a cavity being provided at substantially a central position of the upper surface;
an original cover, the original cover rotatably connected to the housing and selectively covering the upper surface, a light source disposed inside the original cover for reflective scanning operation;
wherein, the slot means selectively accommodating a tray of a first type or a tray of a second type, as the tray of the first type is inserted within the slot means, a reflective scanning operation is performed over an original disposed on the tray of the first type, and as the tray of the second type is inserted within the slot means, a transmissive scanning operation is performed over an original disposed on the tray of the second type.

2. The image scanning apparatus according to claim 1, wherein the slot means is formed by an upper surface of a frame and an inner surface of the housing, a cross-section of the frame is in substantially L-shape, a cross-section of the slot means is in substantially U-shape, the slot means is parallel to a first direction of the housing, and an opening defined by the U-shaped cross-section of the slot means points towards a second direction of the housing, the tray of the first type or the tray of the second type may be selectively inserted within and may slide within the slot means along the first direction.

3. The image scanning apparatus according to claim 1, wherein a means of transparent material which has an upper surface and a lower surface is provided at a main portion of the tray of the first type, and as the tray of the first type is inserted within the slot means, the means of transparent material closes up the cavity.

4. The image scanning apparatus according to claim 1, wherein at least one holder is provided at a main portion of the tray of the second type for accommodating an original of transparent type.

5. The image scanning apparatus according to claim 2, wherein as the first direction is the longitudinal direction, the second direction is the transverse direction.

6. The image scanning apparatus according to claim 2, wherein as the first direction is the transverse direction, the second direction is the longitudinal direction.

7. The image scanning apparatus according to claim 3, wherein when the original cover covers the upper surface, the tray of the first type is allowed to be withdrawn from the slot means by users for cleaning greasy dirt or dust deposited on the upper surface and the lower surface of the means of transparent material.

8. The image scanning apparatus according to claim 3, wherein as the tray of the first type is inserted within the slot means, and an original is disposed on the means of transparent material of the tray of the first type, the reflective scanning is allowed to be performed.

9. The image scanning apparatus according to claim 1, wherein as the tray of the second type is inserted within the slot means and a transmissive scanning operation is being performed, the light source from the original cover passes directly through the transparent originals and a good scanning quality is achieved.
